(19) United States
(12) Patent Application Publication
(10) Pub. No.: US 2013/0252798 A1
(43) Pub. Date: Sep. 26, 2013

(54) METALLIC SULFIDE PHOTOCATALYST FOR CARBON DIOXIDE REDUCTION AND THE PREPARATION FOR THE SAME

(71) Applicants: Yong-Chien LING, Hsinchu (TW); Jen-Yu LIU, Hsinchu (TW)

(72) Inventors: Yong-Chien LING, Hsinchu (TW); Jen-Yu LIU, Hsinchu (TW)

(73) Assignee: NATIONAL TSING HUA UNIVERSITY, HSINCHU (TW)

(21) Appl. No.: 13/426,289

(22) Filed: Mar. 21, 2012

(51) Int. Cl. B01J 27/04; C01G 51/00; C01G 53/11; C01G 3/12; C01G 1/12; C01G 5/00; C01G 15/00; C01G 19/00; C01G 29/00; C01G 30/00; C01G 99/00; C01G 9/08

(52) U.S. Cl. 502/5; 423/561.1; 423/566.1; 502/216

(57) ABSTRACT

Disclosed are the metallic sulfide photocatalyst and its preparation method. The photocatalyst includes at least one soluble metallic salt and a sulfide with the oxidation state of S atom ≦+4. The photocatalyst is afforded by reacting the sulfide with the at least one soluble metallic salt dissolved in the complexing agent. Additionally, the photocatalyst further is customized with co-catalyst such as RuCl to form Ru-carried metallic sulfide photocatalyst. The metallic sulfide photocatalyst and Ru-carried metallic sulfide photocatalyst are capable of effectively reducing CO₂ to CH₃OH under the visible light illumination.

### FIELD OF THE INVENTION

The present invention relates to a photocatalyst. In particular, the present invention relates to a metallic sulfide photocatalyst for reducing carbon dioxide (CO₂) to reproduce methanol (CH₃OH) and the preparation method thereof.

### BACKGROUND OF THE INVENTION

The abundant amount of natural energy has been utilized as fuels from industrial revolution and fossil fuels would be drained off in the 21^{th} century, and thus the environmental pollution and greenhouse effect caused by ignition of fossil fuels urge people to endeavor to reduce greenhouse gases and search for new alternative energies, which would be the alternatives of the un-renewable energy, e.g. petroleum, coal, natural gas, etc.

The principle of photocatalytic CO₂ reduction to CH₃OH lies in that the catalyst is illuminated and excited with light with a specific energy, to reproduce the electron/hole pair. The electrons migrate to the surface of catalyst and reduce H₂O to hydrogen, formic acid, formaldehyde, CH₃OH and so on via a series of reactions, and holes are consumed by the sacrificial agent in the system. The key point for photocatalytic CO₂ reduction to CH₃OH is to prepare a photocatalyst having adequate conductivity band and valence band for visible light illumination. At present, the activities for the photocatalytic CO₂ reduction to CH₃OH disclosed in the literatures still are low.

For instance, Liou et al. (Energy Environ. Sci., 2011, 4, 1487-1494) discloses that sol-gel prepared SiO₂ and NiO/InTaO₄ are coated sequentially on monolith to form a multilayer structure, and the catalyst was calcined to form crystal at 1100° C. The gas photocatalysis for CO₂ reduction to CH₃OH and acetaldehyde is performed using prepared cellular reactor. However, the CH₃OH yield only achieves 0.16 μmol g⁻¹ h⁻¹ with visible light intensity of 42.46 mW/cm² (290 klx) at 25° C.

In addition, Shi et al. (Catal. Lett., 2011, 141, 525-530) discloses that NaNbO₃ nanowire is the photocatalyst for reducing CO₂ to CH₃OH and methane, and methane yield is 653 ppm g⁻¹ h⁻¹. However, photocatalysis is carried out under ultraviolet (UV) light, and thus significantly influences its application value.

In addition, Tsai et al. (J. Phys. Chem., 2011, 115, 10180-10186) discloses that N-doped InTaO₄ photocatalyst is manufactured by doping nickel and using modified Ni@NiO core-shell nanostructure, and is able to reduce CO₂ to CH₃OH. Although CH₃OH yield of N-doped InTaO₄ photocatalyst is 175 μmol g⁻¹ h⁻¹, manufacture at 1100° C. for 12 hours is essential. It cannot fulfill the economic efficiency and cost the abundant energy and heat.

Therefore, if a photocatalyst can be prepared under the low-energy consumption and low-temperature conditions, can proceed photocatalysis under visible light to reduce CO₂ to abundant CH₃OH or other renewable energies or materials, and its energy band gap and the conductivity band and valence band position can be adjusted in demand, it will be beneficial to the environmental protection and the development of novel energy.

It is therefore attempted by the applicant to deal with the aforementioned situation encountered in the prior art.

### SUMMARY OF THE INVENTION

In the present invention, the metallic compound reacts with sulfuric compound to form the metallic sulfide photocatalyst, which is able to reduce CO₂ and reproduce methanol (CH₃OH) after the absorption of sunlight or visible light.

The present invention provides a metallic sulfide, including a dissoluble metallic salt being selected from a dissoluble transition metallic salt, a dissoluble post-transition metallic salt and/or a dissoluble metalloid salt, and a sulfide having a sulfur atom with oxidation state smaller than or equal to +4.

The dissoluble transition metallic salt includes but is not limited to a dissoluble cobalt salt, a dissoluble nickel salt, a dissoluble cupper salt, a dissoluble zinc salt and a dissoluble silver salt. The dissoluble post-transition metallic salt includes but is not limited to a dissoluble indium salt, a dissoluble tin salt and a dissoluble bismuth salt. The dissoluble metalloid salt includes but is not limited to a dissoluble antimony salt.

The present invention further provides a preparation method of a metallic sulfide, including steps of: (a) dissolving a dissoluble metallic salt in a complexing agent to form a first reactant; (b) dissolving a sulfide in a water to form a second reactant; and (c) adding the second reactant to the first reactant to form the metallic sulfide. The first reactant preferably has an amount more than five times of an amount of the second reactant.

The complexing agent includes but is not limited to aqueous ammonia, a hydroxyl-bounding carboxylic acid salt, a polycarboxylic acid salt and a monocarboxylic acid salt. The sulfide includes but is not limited to dimethyl disulfide, S-methyl methanethiolsulfonate, α-chlorodimethylsulfone and α-methylsulfonyl-α,α-dichlorodimethylsulfone.

The preparation method further includes a step of (c1) drying the metallic sulfide to form a powder of the metallic sulfide.

Furthermore, the preparation method further includes steps of: (d) adding a metallic compound to the metallic sulfide to form a third reactant; and (e) illuminating the third reactant with a light source (e.g. xenon lamp) to form a metallic compound-carried metallic sulfide. Preferably, the step (e) is performed between 25° C. and 600° C.

The metallic compound includes but is not limited to the acidic metallic oxide which has the characteristic of Lewis acid and/or Brønsted acid, and/or the basic metallic compound which has the characteristic of Lewis base and/or Brønsted base.

The present invention further provides a preparation method of a metallic sulfide, including a step of reacting at least one dissoluble metallic salt with a sulfide to form the metallic sulfide.

Preferably, the preparation method further includes a step of reacting the metallic sulfide with a metallic compound to form a metallic compound-carried metallic sulfide.

The above objectives and advantages of the present invention will become more readily apparent to those ordinarily skilled in the art after reviewing the following detailed descriptions and accompanying drawings.

### BRIEF DESCRIPTION OF THE DRAWINGS

FIG. 1 depicts a diagram showing CH₃OH yield from the CO₂ photoreduction of the metallic sulfide photocatalysts which are prepared by modifying the stoichiometric coefficient of Cu:Ag:In:Zn:S.

FIG. 2 depicts a diagram showing CH₃OH yield from the CO₂ photoreduction by the rubidium-carried metallic sulfide photocatalysts which are prepared by modifying the stoichiometric coefficient of Cu:Ag:In:Zn:S.

FIG. 3 is a diagram showing the reflective UV-VIS spectra of samples A7, A9 and A10 of the metallic sulfide photocatalyst.

FIG. 4 is a diagram showing the reflective UV-VIS spectra of samples B7, B9 and B10 of the metallic sulfide photocatalyst.

FIG. 5 depicts the FE-SEM image of the metallic sulfide photocatalyst.

FIG. 6 is the X-ray diffraction spectra of samples A7, A9 and A10 of the metallic sulfide photocatalyst.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

The metallic sulfide photocatalyst of the present invention includes at least one dissoluble metallic salt and a sulfide. The examples of the dissoluble metallic salt includes but is not limited to dissoluble transition metallic salt, dissoluble post-transition metallic salt, dissoluble metalloid salt and so on, and these dissoluble salts can be used alone or more than two dissoluble salts can be combined for use.

As to the dissoluble transition metallic salt, the inorganic salts or organic salts of metallic ion, e.g. cobalt (Co²⁺, Co³⁺), nickel (Ni²⁺), copper (Cu⁺, Cu²⁺), zinc (Zn²⁺), silver (Ag⁺) and so on, may be used. Dissoluble cobalt salt includes but is not limited to the cobalt salt for cobalt sulfate, cobalt chloride and organic sulfonic acid. Dissoluble nickel salt includes but is not limited to nickel salt for nickel sulfate, nickel chloride, ammonium nickel sulfate, nickel oxide, nickel acetate and organic sulfonic acid. Dissoluble copper salt includes but is not limited to nickel salt for copper sulfate, copper chloride, copper oxide, copper carbonate, cupric acetate, copper pyrophosphate and cupric oxalate. Dissoluble zinc salt includes but is not limited to the salt for zinc chloride, zinc sulfate, zinc oxide, organic zinc sulfonic acid and zinc sulfosuccinate. Dissoluble silver salt includes but is not limited to salt for silver methanesulfonate, silver ethanesulfonate, silver 2-propanesulfonate, silver cyanide, silver fluoroborate, silver sulfate, silver sulfite, silver carbonate, silver sulfosuccinate, silver nitrate, silver citrate, silver tartrate, silver gluconic acid, silver oxalate, silver oxide and silver acetate.

As to dissoluble post-transition metallic salt, inorganic salt or organic salt of metallic ion, e.g. indium (In³⁺, tin, bismuth (Bi³⁺) and so on, may be used. Dissoluble indium salt includes but is not limited to indium chloride, indium oxide, organic indium sulfonic acid. Dissoluble bismuth salt includes but is not limited to bismuth salt for bismuth sulfate, bismuth oxide, bismuth chloride, bismuth bromide, bismuth nitrate, organic sulfonic acid and sulfosuccinate.

The example of dissoluble metalloid salt includes dissoluble antimony salt, which includes but is not limited to the salt for antimony chloride, antimony fluoroborate, organic sulfoantimony and so on.

The sulfide is an sulfuric compound which has an oxidation state of S atom not larger than +4. That is, the oxidation state of sulfur is not at the largest condition, and S atom would result in the sulfide as an incomplete octet structure. The sulfide includes but is not limited to dimethyl disulfide, S-methyl methanethiolsulfonate, α-chlorodimethylsulfone and α-methylsulfonyl-α,α-dichlorodimethylsulfone.

The metallic sulfide photocatalyst of the present invention may be synthesized at a pH range of acid-neutral or base. Generally, metallic compound is stable in acidic circumstance while becomes to be unstable near neutral pH. Therefore, for stabilizing the metallic compound and avoiding the generation of while precipitate upon synthesis at a pH range near 7, one or more complexing agents are added to the metallic compound. The complexing agent includes but is not limited to aqueous ammonia and the salts of hydroxyl-bounding carboxylic acid, polycarboxylic acid, monocarboxylic acid, e.g. salts of gluconic acid, citric acid, glucoseheptylate, glucono-δ-lactone, D-glucoheptono-1,4-lactone, formic acid, acetic acid, propionic acid, chromic acid, ascorbic acid, oxalic acid, propanedioic acid, succinic acid, glycolic acid, malic acid, tartaric acid and diglycolic acid. The salts of gluconic acid, citric acid, glucoseheptylate, glucono-δ-lactone and D-glucoheptono-1,4-lactone are preferred. In Addition, the salts such as ethylenediamine, EDTA (ethylenediaminetetraacetic acid), DTPA (diethylenetriaminepentaacetate), NTA (nitrilotriacetic acid), IDA (iminodiacetate), IDP (iminodipropionic acid), HEDTA (N-(hydroxyethyl)ethylenediaminetriacetic acid), TTHA (triethylenetetramine hexacetic acid), ethylenediamine-N,N,N′,N′-tetraacetic acid, glycine, nitrilotrimethylsulfonic acid, 1-hydroxyethane-1,1-disulfonic acid and so on are also the effective complexing agents.

In accordance with the aforementioned description, the preferred embodiment of the present invention is CuAgInZnS photocatalyst, and its manufacturing method is provided as follows. 1) Cuprous chloride, silver nitrate, indium nitrate and zinc nitrate were dissolved in deionized water based on stoichiometric coefficient, and aqueous ammonia was added to prepare the salt solution, 2) thioacetamide was dissolved in deionized water to prepare the thioacetamide solution, 3) thioacetamide solution was added with an amount more than five times of the salt solution at ambient temperature to obtain the mixture solution, and 4) the mixture solution was washed and dried to yield CuAgInZnS photocatalyst. In addition, Rb-carried CuAgInZnS photocatalyst was made by adding a step of 5) adding rubidium chloride to CuAgInZnS photocatalyst, which is further reduced with xenon light source to obtain Rb-carried CuAgInZnS photocatalyst after step 4).

The drying means for metallic sulfide photocatalyst was calcined at the temperature between 300° C. and 600° C. (preferably at 320° C.) for 1 to 24 hours (preferably for 5 hours). Before calcining, metallic sulfide photocatalyst could be washed with water at a temperature between 10° C. and 70° C. (or a temperature between 70° C. and 200° C., and preferably at 150° C.), and the dispersed metallic sulfide photocatalyst had a particle size between 0.05 μm and 0.5 μm.

Acidic metallic oxide, basic metallic compound or both may be carried on the surface of metallic sulfide photocatalyst. Acidic metallic oxide, which has the characteristics of Lewis acid and/or Brønsted acid, includes monometallic oxide and dimetallic oxide, wherein monometallic oxide is preference. Basic metallic compound, which has the characteristic of Lewis base and/or Brønsted base, includes monovalent or divalent metallic oxide, monovalent or divalent hydroxide, and monovalent or divalent metallic carbonate.

The monometallic oxide of the acidic metallic oxide includes but is not limited to Zr, Pb, V, Nb, Ta, Mo, W, Mn, Fe, Co, Ni, Cu, Al, Ga, In and Sn. The dimetallic oxide includes but is not limited to Si—Zn, Si—Zr, Si—Mg, Si—Ca, Si—Ga, Si—Al, Si—La, Si—Zn, Ti—Zn, Ti—Cu, Ti—Zn, Ti—Al, Ti—Zr, Ti—Pb, Ti—Bi, Ti—Fe, Zn—Mg, Zn—Al, Zn—Zr, Zn—Pb and Zn—Sb.

The basic metallic compound includes but is not limited to monovalent or divalent metallic oxide from sodium oxide, potassium oxide, magnesium oxide, calcium oxide, barium oxide, lanthanum oxide, cerium oxide and zinc oxide, and monovalent or divalent metallic oxide from sodium hydroxide, potassium hydroxide, magnesium hydroxide, calcium hydroxide, barium hydroxide, lanthanum hydroxide, cerium hydroxide and zinc hydroxide, or monovalent or divalent metallic carbonate from sodium carbonate, potassium carbonate, magnesium carbonate, calcium carbonate, barium carbonate, copper carbonate, cerium carbonate and zinc carbonate, and so on.

As aforementioned, metallic sulfide photocatalyst may carry the acidic metallic oxide and basic metallic compound simultaneously. Alternatively, the acidic metallic oxide-carried metallic sulfide photocatalyst and the basic metallic compound-carried metallic sulfide photocatalyst may be mixed with each other and use simultaneously.

Metallic sulfide photocatalyst can be manufactured as various configurations, including but is not limited to molding artifact, fiber and powder. The metallic sulfide photocatalyst may be mixed with adhesive, antistatic agent, adsorbent, inorganic polymer and/or organic polymer, etc. to obtain the molding artifact. The metallic sulfide photocatalyst may be mixed with inorganic polymer or organic polymer and wiredrew to form the fiber product, wherein the inorganic compound includes but is not limited to silicon dioxide (SiO₂), aluminum oxide (Al₂O₃), zirconium oxide (ZrO₂), magnesium oxide (MgO), zinc oxide (ZnO) and the inorganic material which may be illuminated with visible light to perform photocatalysis. The metallic sulfide photocatalyst may be comminuted, sieved and/or graded as powdered level product. In addition, one skilled in the art further can manufacture the coating composition from the metallic sulfide photocatalyst and the solvent.

The metallic sulfide photocatalyst can be preserved in other liquids or gases, and may be illuminated with visible light to proceed photocatalysis, so that CO₂ in the ambient atmosphere is reduced to CH₃OH. The preferred wavelength of visible light is ranged from 430 nm to 600 nm. The light source of visible light includes but is not limited to sunlight, fluorescent lamp, halogen lamp, nitrogen-filled lamp, mercury arc lamp, light-emitting diode (LED), electroluminescent lamp. The UV-truncation filter and/or infrared (IR)-truncation filter for the light source may be configured in demand. The illumination time of visible light depends on the light intensity of light source, and the types and concentrations of compound to be treated by photocatalyst.

The photocatalysis driven by the metallic sulfide photocatalyst of the present invention also can be proceeded to decompose organic compounds (e.g. organic acid such as acetic acid, etc.), to decompose NOₓ, cigarette odor, unpleasant odor or stale odor in the atmosphere, to decompose environmental pollutants (e.g. organic solvents, agrochemicals and surfactants) in the water, and to inhibit growth of microbe (e.g. bacteria, algae, fungi, etc.).

### Embodiment 1

### Preparation of Sulfide Photocatalyst

Cuprous chloride, silver nitrate, indium nitrate and zinc nitrate were dissolved in deionized water based on the stoichiometric coefficient, and aqueous ammonia was added to obtain a salt solution with a total concentration of 0.01 mole/L to 0.2 mole/L. Next, thioacetamide was dissolved in deionized water to obtain a thioacetamide solution with a concentration of 0.1 mole/L to 1 mole/L. The thioacetamide solution, more than 5× quantities, was added with stirring to the salt solution at a rate of 0.01 mL/min to 2 mL/min at room temperature, and stirring was succeeded for at least 1 min to form the mixture solution. The mixture solution was filtered, washed, and dried in the oven at 25° C. to 600° C. for 1 to 12 hours. A photocatalyst with a formula of CuₓAg_{y}In_{z}ZnₖSⱼ was yielded after comminuting.

Rubidium chloride was added to the solution of CuₓAg_{y}In_{z}ZnₖSⱼ photocatalyst at a weight ratio of 0.00 to 0.01, and the CuₓAg_{y}In_{z}ZnₖSⱼ photocatalyst was reduced as Ru/CuₓAg_{y}In_{z}ZnₖSⱼ photocatalyst under the illumination of xenon lamp. After drying in the oven at 25° C. to 600° C. and comminuting, Ru/CuₓAg_{y}In_{z}ZnₖSⱼ photocatalyst was yielded, and abbreviated as Ru(a)/CuₓAg_{y}In_{z}ZnₖSⱼ.

The Ru(a)/CuₓAg_{y}In_{z}ZnₖSⱼ of the present invention has a high photocatalytic activity under the visible light illumination, and displays the visible-light driven catalytic activity for CO₂ reduction to CH₃OH much higher than the doped or solid solution catalyst alone, such as copper-doped zinc sulfide or ZnₓCd₁₋ₓS photocatalyst. The highest rate for CO₂ reduction to reproduce CH₃OH obtained by the miniature reaction device was 21.1 μmol g⁻¹ h⁻¹. If hydrogen (1 a.t.m.) was introduced, the rate increased further to 118.5 μmol g⁻¹ h⁻¹.

### Example 1

The preparation method of AgInZnS photocatalyst is described as follows. 1) Silver nitrate, indium nitrate and zinc nitrate were dissolved in deionized water based on the stoichiometric coefficient of Ag:In:Zn=1:1:7, and aqueous ammonia was added to obtain the salt solutions with a total concentration of 0.01, 0.01 and 0.07 mol/L respectively. 2) Thioacetamide was dissolved in deionized water to obtain a thioacetamide solution (0.1 mole/L). 3) The thioacetamide solution, more than 5× quantities, was added dropwise with stirring to the salt solution at 2 mL/min at room temperature, for form the mixture solution. After addition, stirring was succeeded for 1 h to form the mixture solution. 4) The obtained mixture solution was filtered, washed, and dried in the oven at 100° C. for 12 hours, and the metallic sulfide photocatalyst was yielded after comminuting.

### Example 2

The preparation method of Ru(a)/CuₓAg_{y}In_{z}ZnₖSⱼ photocatalyst is described as follows. 1) Cuprous chloride, silver nitrate, indium nitrate and zinc nitrate were dissolved in deionized water based on the stoichiometric coefficient of Cu:Ag:In:Zn=1:1:1:7, and aqueous ammonia was added to obtain the salt solutions of 0.01, 0.01, 0.01 and 0.07 mol/L respectively. Step 2) to step 4) were the carried out as described in Example 1, and thus CuₓAg_{y}In_{z}ZnₖSⱼ photocatalyst was obtained. 5) Rubidium chloride at a weight ratio of 0.01 was added to the solution of CuₓAg_{y}In_{z}ZnₖSⱼ photocatalyst, which then was reduced as Ru(a)/CuₓAg_{y}In_{z}ZnₖSⱼ photocatalyst under the xenon illumination, dried in the oven at 100° C. for 4 h, and comminuted to yield the powder of Ru(a)/CuₓAg_{y}In_{z}ZnₖSⱼ photocatalyst.

### Example 3

The preparation method of CuₓAg_{y}In_{z}ZnₖSⱼ photocatalyst is described as follows. 1) Cuprous chloride, silver nitrate, indium nitrate and zinc nitrate were dissolved in deionized water based on the stoichiometric coefficient of Cu:Ag:In:Zn=0.38:0.12:0.5:1.0, and aqueous ammonia was added to obtain the salt solutions of 0.002, 0.0064, 0.0268 and 0.0536 mol/L respectively. Step 2) to step 4) were carried out as described in Example 1, and thus CuₓAg_{y}In_{z}ZnₖSⱼ photocatalyst was obtained.

### Example 4

The preparation method of Ru(a)/CuₓAg_{y}In_{z}ZnₖSⱼ photocatalyst is described as follows. 1) Cuprous chloride, silver nitrate, indium nitrate and zinc nitrate were dissolved in deionized water based on the stoichiometric coefficient of Cu:Ag:In:Zn=0.38:0.12:0.5:1.0, and aqueous ammonia was added to obtain the salt solutions of 0.002, 0.0064, 0.0268 and 0.0536 mol/L respectively. Step 2) to step 4) were the carried out as described in Example 1, and thus CuₓAg_{y}In_{z}ZnₖSⱼ photocatalyst was obtained. 5) Rubidium chloride at a weight ratio of 0.01 was added to the solution of CuₓAg_{y}In_{z}ZnₖSⱼ photocatalyst, which then was reduced as Ru(a)/CuₓAg_{y}In_{z}ZnₖSⱼ photocatalyst under the xenon illumination, dried in the oven at 100° C. for 4 h, and comminuted to yield the powder of Ru(a)/CuₓAg_{y}In_{z}ZnₖSⱼ photocatalyst.

### Example 5

The preparation method of CuₓAg_{y}In_{z}ZnₖSⱼ photocatalyst is described as follows. 1) Cuprous chloride, silver nitrate, indium nitrate and zinc nitrate were dissolved in deionized water based on the stoichiometric coefficient of Cu:Ag:In:Zn=0.12:0.38:0.5:1.0, and aqueous ammonia was added to obtain the salt solutions of 0.0064, 0.002, 0.0268 and 0.0536 mol/L respectively. Step 2) to step 4) were carried out as described in Example 1, and thus CuₓAg_{y}In_{z}ZnₖSⱼ photocatalyst was obtained.

### Example 6

The preparation method of CuₓAg_{y}In_{z}ZnₖSⱼ photocatalyst is described as follows. 1) Cuprous chloride, silver nitrate, indium nitrate and zinc nitrate were dissolved in deionized water based on the stoichiometric coefficient of Cu:Ag:In:Zn=0.37:0.37:0.35:1.0, and aqueous ammonia was added to obtain the salt solutions of 0.02, 0.02, 0.013 and 0.0536 mol/L respectively. Step 2) to step 4) were carried out as described in Example 1, and thus CuₓAg_{y}In_{z}ZnₖSⱼ photocatalyst was obtained.

The above examples are only the exemplary cases, and CuₓAg_{y}In_{z}ZnₖSⱼ photocatalyst and Ru(a)/CuₓAg_{y}In_{z}ZnₖSⱼ photocatalyst could be obtained within the protecting scope of the present invention.

Ten metallic sulfide photocatalyst and ten Ru-carried CuAgInZnS photocatalyst samples (referring to Table 1) were prepared in accordance with the aforementioned examples, and the respective element ratios were determined in accordance with the total mole from each element precursor used upon preparation.

TABLE 1

| Sam- | | | |
|---|---|---|---|
| ple | | Sample | |
| No. | Formula | No. | Formula |
| A1 | AgInZn₇S₉ | B1 | Ru(0.01)/AgInZn₇S₉ |
| A2 | AgInZn₇S₉ | B2 | Ru(0.01)/AgInZn₇S₉ |
| A3 | Cu_{0.25}Ag_{0.25}In_{0.5}ZnS₂ | B3 | Ru(0.01)/Cu_{0.25}Ag_{0.25}In_{0.5}ZnS₂ |
| A4 | Cu_{0.5}Ag_{2.25}InZn₇S₁₁ | B4 | Ru(0.01)/Cu_{0.5}Ag_{2.25}InZn₇S₁₁ |
| A5 | CuAgInZn₇S₁₀ | B5 | Ru(0.01)/CuAgInZn₇S₁₀ |
| A6 | Cu_{0.5}Ag_{0.5}In_{0.5}ZnS₂ | B6 | Ru(0.01)/Cu_{0.5}Ag_{0.5}In_{0.5}ZnS₂ |
| A7 | Cu_{0.38}Ag_{0.12}In_{0.5}ZnS₂ | B7 | Ru(0.01)/Cu_{0.38}Ag_{0.12}In_{0.5}ZnS₂ |
| A8 | Cu_{0.12}Ag_{0.38}In_{0.5}ZnS₂ | B8 | Ru(0.01)/Cu_{0.12}Ag_{0.38}In_{0.5}ZnS₂ |
| A9 | Cu_{0.12}Ag_{0.12}In_{0.75}ZnS₂ | B9 | Ru(0.01)/Cu_{0.12}Ag_{0.12}In_{0.75}ZnS₂ |
| A10 | Cu_{0.37}Ag_{0.37}In_{0.25}ZnS₂ | B10 | Ru(0.01)/Cu_{0.37}Ag_{0.37}In_{0.25}ZnS₂ |

### Embodiment 2

### Capability of CH₃OH Reproduction with Photocatalysts

The experimental method for the visible light photoreduction of CO₂ to CH₃OH is described as follows. The photocatalyst (0.05 g), sodium hydrogen bicarbonate (0.21 g, the source of CO₂) and the sacrificial agent (including a mixture solution of 0.25 mol/L Na₂SO₃ and 0.25 mol/L Na₂S, and 25 mL deionized water) were added in the Pyrex glass reactor. Before illumination, nitrogen was introduced into the Pyrex for scavenging for 10 min and for purging out oxygen in the system. If the experiment was performed under hydrogen atmosphere, hydrogen (1 a.t.m.) was introduced to the Pyrex to replace other gases. Next, the UV light below 400 nm wavelength was filtered by the sodium nitrite solution (2 M). Photocatalysis was performed for a period of time at 35±5° C. under the xenon lamp (1000 W), and the liquid (3 μL) was sampled from the Pyrex to perform the analysis of gas composition using gas chromatograph-flame ionization detector (GC-FID, GC2000, FID detector, Porapak Q column, China Chromatography Co., Ltd.).

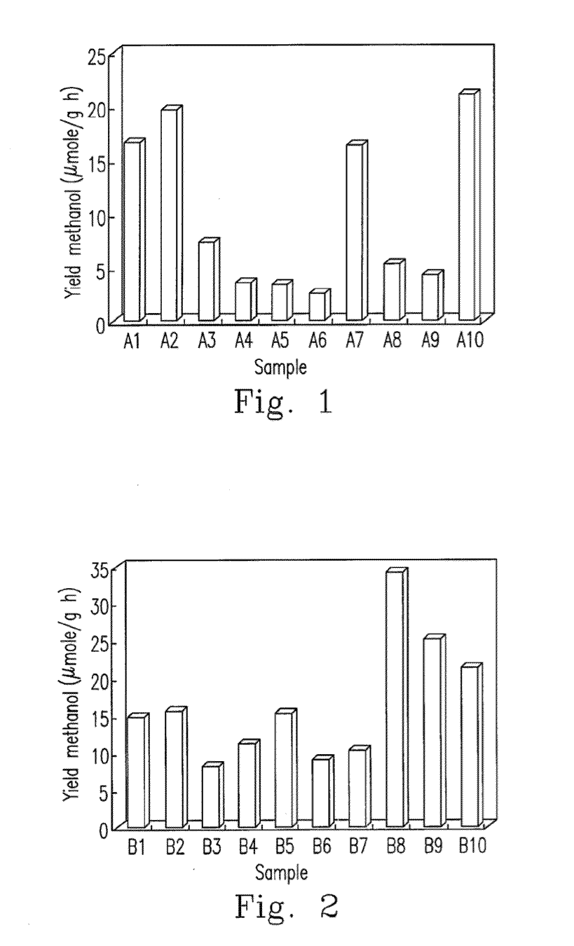

Please refer to FIG. 1, the CH₃OH reproduction rate of photocatalysis on sample A10 (Cu_{0.37}Ag_{0.37}In_{0.25}ZnS₂, 21.1 μmol g⁻¹ h⁻¹) is higher than that on sample A7 (Cu_{0.38}Ag_{0.12}In_{0.5}ZnS₂). If hydrogen (1 a.t.m.) was introduced, photocatalysis on sample A7 will yield a CH₃OH reproduction rate of 118.5 μmol g⁻¹ h⁻¹, indicating that more hydrogen free radicals will be provided to enhance the reduction under the hydrogen atmosphere. Please refer to FIG. 2, the CH₃OH reproduction rate of photocatalysis on sample B8 (Ru(0.01)/Cu_{0.12}Ag_{0.38}In_{0.5}ZnS₂) is much higher than that on sample B10 (Ru(0.01)/Cu_{0.37}Ag_{0.37}In_{0.25}ZnS₂). The results in FIG. 1 and FIG. 2 show that the modification of the metal ratio of the CuAgInZnS photocatalyst or the Ru/CuAgInZnS photocatalyst will effectively proceed the CO₂ reduction to CH₃OH.

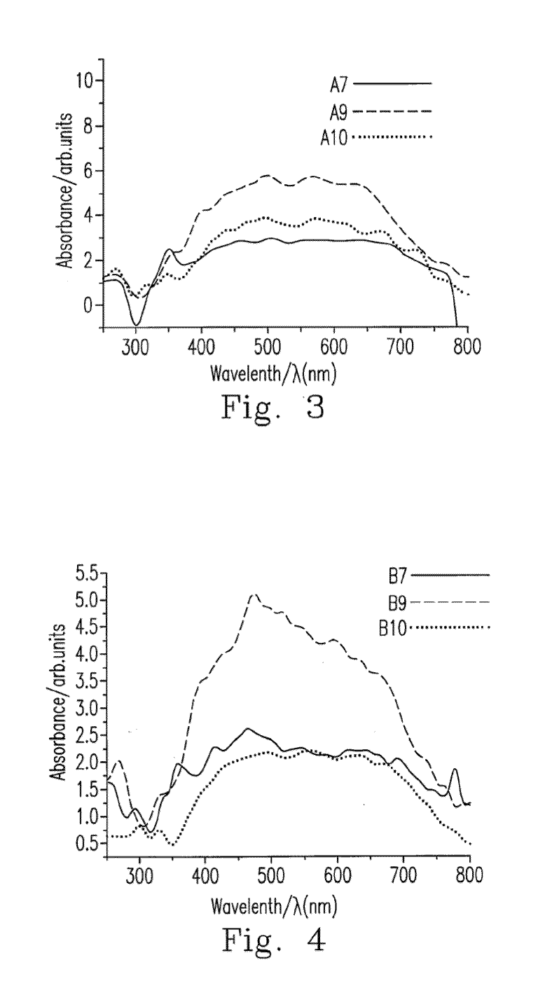

Please refer to FIG. 3 and FIG. 4, which are the reflective UV-VIS spectra of the photocatalysts of the present invention. The reflective UV-VIS spectrum assay is well known to one ordinarily skilled in the art, and the detailed experimental method will not be described herein. FIG. 3 and FIG. 4 reveal that samples A7, A9 and A10, and samples B7, B9 and B10 can absorb visible light at the wavelength of 430 nm to 600 nm, and visible light also can be absorbed at the wavelength below 430 nm or above 600 nm, suggesting that phtocatalysis is carried out by the metallic sulfide photocatalysts or the Ru-carried metallic sulfide photocatalysts of the present invention.

Since the conductivity bands of In₂S₃ and ZnS are made up of In 5s5p and Zn 4s4p respectively, suggesting that In 5s5p and Zn 4s4p of the CuₓAg_{y}In_{z}ZnₖSⱼ photocatalyst are cooperated with each other to form the conductivity band of the solid solution, and S 3p, Cu 3d and Ag 4d thereof are cooperated to form the valence band of the solid solution. The absorbance of the CuₓAg_{y}In_{z}ZnₖSⱼ photocatalyst in the VIS spectrum is higher than that in the UV spectrum. It is known from FIG. 3 and FIG. 4 that the narrow energy band gap of silver sulfide (Ag₂S, 1.4 eV) gives the larger contribution than the wide one of indium sulfide (In₂S₃, 2.49 eV) when the Ag/In ratio of the photocatalyst is high. Therefore, the CuₓAg_{y}In_{z}ZnₖSⱼ photocatalyst has the higher absorption coefficient in the VIS spectrum, that is, silver atom and indium atom access the crystalline skeleton of photocatalyst.

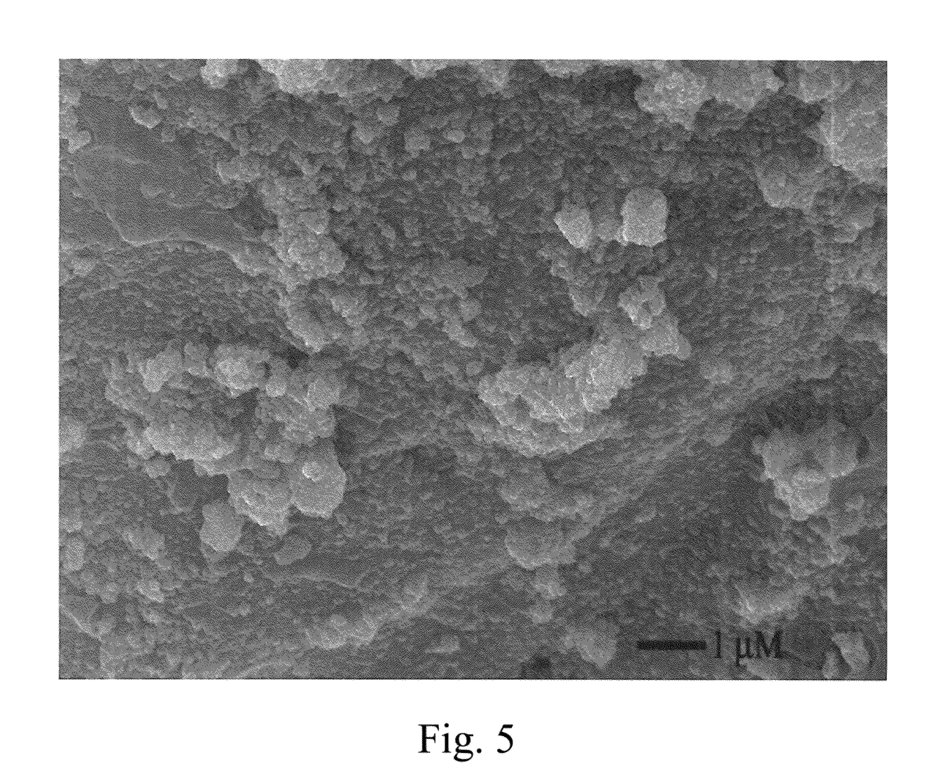

Please refer to FIG. 5, which is the FE-SEM (field-emission scanning electron microscopy) image of the metallic sulfide photocatalyst (with a formula of Cu₀Ag₁In₁Zn₇S₉) obtained at a beam voltage of 15.0 kV, a magnification of 10,000×, a working distance (WD) of 9.2 mm and a second electron image (SEI), suggesting that the particles of Cu₀Ag₁In₁Zn₇S₉ photocatalyst are formed by aggregation of grains with 100 nm in size. Since the nano-scaled metallic sulfide photocatalyst results in the generation of quantum effect, its energy band gap becomes wider so that the oxidoreduction capability is enhanced.

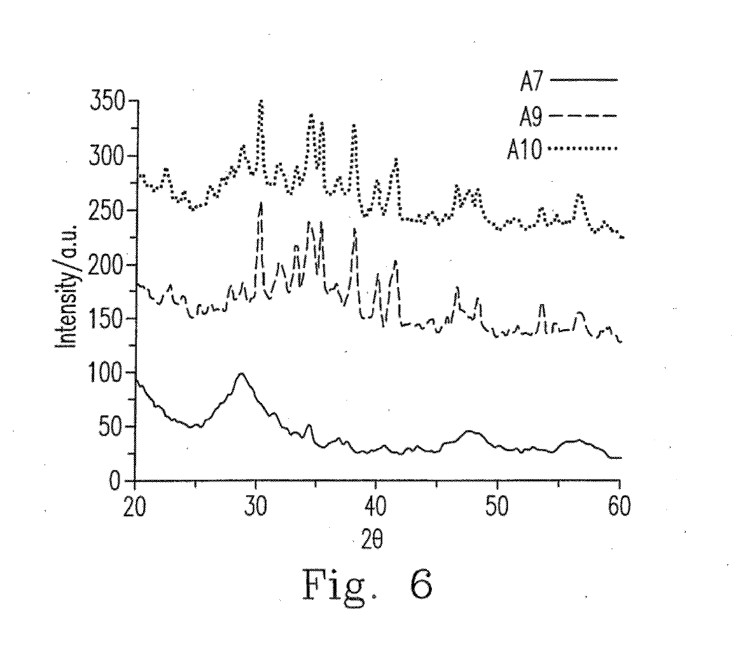

Please refer to FIG. 6, which is the X-ray diffraction spectra of samples A7, A9 and A10 of the metallic sulfide photocatalyst, in which abscissa and ordinate are referred to scanning angle (2θ) and signal intensity, respectively. It can be known from FIG. 6 that the photocatalyst represents a wurtzite structure with the increased silver ratio therein (Ag ratio in samples A7, A9 and A10 are 0.12, 0.12, 0.37, respectively), and represents a sphalerite structure with the increased copper ratio therein (Cu ratio in samples A9, A10 and A7 are 0.12, 0.37 and 0.38, respectively). When Cu ratio is increased with respect to Ag ratio in the photocatalyst, the diffraction peak of photocatalyst is moved toward the high angle direction due to the radius of Cu⁺ (0.74 nm) smaller than that of Ag⁺ (0.114 nm). That is, the photocatalyst of the present invention represents a solid solution structure with formation of CuₓAg_{y}In_{z}ZnₖSⱼ, rather than a mixed crystalline structure with formation of ZnS, CuInS₂ and/or AgInS₂.

### CONCLUSION

The metallic sulfide photocatalyst of the present invention has an excellent absorption activity in visible light, ensures that the energy in the VIS spectrum can be adequately used by the photocatalyst. Furthermore, since Zn is the major component of the phototcatalyst, it guarantees that the high conductivity band position of the phototcatalyst results in the strong reduction of photoelectrons. Furthermore, the small particle size of the photocatalyst results in that the photoelectrons and holes migrate to the surface active sites of photocatalyst in a short time period and inhibit the combination of photocarriers. Additionally, rubidium carrier provides more reaction active sites for the photocatalysis. When photocarriers migrate to the surface of photocatalyst, the photocatalyst can speedily react with the oxidative or reductive species in the solution and inhibits the surface combination of photocarriers. Therefore, the metallic sulfide photocatalyst has high photoreduction CO₂ activity towards CH₃OH reproduction under visible light illumination, and high-temperature conditions and high-energy consumption are unnecessary in the preparing process.

Therefore, the metallic sulfide photocatalyst of the present invention can reduce CO₂ to reproduce CH₃OH since the energy band gap becomes narrower and thus more photons are effectively absorbed to reproduce photocarriers. In addition, the metallic sulfide photocatalyst can be designed as the photocatalyst with the adequate conductivity band and valence band position to remove volatile organic compounds.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A metallic sulfide, comprising:
a dissoluble metallic salt being selected from a group consisting of a dissoluble transition metallic salt, a dissoluble post-transition metallic salt, a dissoluble metalloid salt and a combination thereof; and
a sulfide having a sulfur atom with an oxidation state being one of smaller than and equal to +4.

2. The metallic sulfide according to claim 1, wherein the dissoluble transition metallic salt is selected from a group consisting of a dissoluble cobalt salt, a dissoluble nickel salt, a dissoluble cupper salt, a dissoluble zinc salt, a dissoluble silver salt and a combination thereof.

3. The metallic sulfide according to claim 1, wherein the dissoluble post-transition metallic salt is selected from a group consisting of a dissoluble indium salt, a dissoluble tin salt, a dissoluble bismuth salt and a combination thereof.

4. The metallic sulfide according to claim 1, wherein the dissoluble metalloid salt is a dissoluble antimony salt.

5. A preparation method of a metallic sulfide, comprising steps of:
(a) dissolving a dissoluble metallic salt in a complexing agent to form a first reactant;
(b) dissolving a sulfide in a water to form a second reactant; and
(c) adding the second reactant to the first reactant to form the metallic sulfide.

6. The preparation method according to claim 5 further comprising a step of (c1) drying the metallic sulfide to form a powder of the metallic sulfide.

7. The preparation method according to claim 5, wherein the complexing agent is selected from a group consisting of an aqueous ammonia, a hydroxyl-bounding carboxylic acid salt, a polycarboxylic acid salt, a monocarboxylic acid salt and a combination thereof.

8. The preparation method according to claim 5, wherein the sulfide is selected from a group consisting of a dimethyl disulfide, an S-methyl methanethiolsulfonate, an α-chlorodimethylsulfone, an α-methylsulfonyl-α,α-dichlorodimethylsulfone and a combination thereof.

9. The preparation method according to claim 5 further comprising steps of:
(d) adding a metallic compound to the metallic sulfide to form a third reactant; and
(e) illuminating the third reactant with a light source to form a metallic compound-carried metallic sulfide.

10. The preparation method according to claim 9, wherein the metallic compound is selected from a group consisting of an acidic metallic oxide, a basic metallic compound and a combination thereof.

11. The preparation method according to claim 10, wherein the acidic metallic oxide has a characteristic of at least one of a Lewis acid and a Brønsted acid.

12. The preparation method according to claim 10, wherein the basic metallic oxide has a characteristic of at least one of a Lewis base and a Brønsted base.

13. The preparation method according to claim 9, wherein the light source is an xenon lamp, and the step (e) is performed at a temperature between 25° C. and 600° C.

14. The preparation method according to claim 5, wherein the first reactant and the second reactant respectively have a first amount and a second amount, and the second amount is more than five times of the first amount.

15. A preparation method of a metallic sulfide, comprising a step of reacting at least one dissoluble metallic salt with a sulfide to form the metallic sulfide.

16. The preparation method according to claim 15 further comprising a step of reacting the metallic sulfide with a metallic compound to form a metallic compound-carried metallic sulfide.
